(19) United States
(12) Patent Application Publication
(10) Pub. No.: US 2023/0237540 A1
(43) Pub. Date: Jul. 27, 2023

(54) Methods and Systems for Facilitating Donations to User Preferred Charitable Entities

(71) Applicant: Shivam Goyal, San Juan, PR (US)

(72) Inventor: Shivam Goyal, San Juan, PR (US)

(21) Appl. No.: 18/161,027

(22) Filed: Jan. 27, 2023

Related U.S. Application Data
(60) Provisional application No. 63/303,615, filed on Jan. 27, 2022.

(51) Int. Cl. G06Q 30/0279; G06Q 30/0217; G06Q 20/10

(52) U.S. Cl. CPC G06Q 30/0279; G06Q 30/0218; G06Q 20/10

(57) ABSTRACT

Methods and systems for facilitating donations to user preferred causes are disclosed herein. In accordance with one embodiment of the invention, the method comprises the steps of collecting a plurality of information corresponding to a user preferred payment methods and user preferred causes, detecting the users engagement in commerce, calculating a donation amount, prompting the user to verify or update the donation amount and causes the donation is for, and, in response to the user verifying the donation amount and causes, transferring the donation amount from the user preferred payment methods to the causes. In some embodiments, this method further comprises donation batching. In some embodiments, this method further comprises calculating and displaying an impact score corresponding to the quantitative or qualitative representation of the tangible effect of the donation based on the donation amount and the causes donated to.

### RELATED APPLICATIONS

This application is related to a provisional application 63/303,615, filed January 27^{th} of 2022. All the teachings of the provisional application are incorporated here by reference. The current application claims priority to the filing date of the provisional application.

### TECHNICAL FIELD

The present disclosure relates generally to online donations. More specifically, the present invention relates to methods and systems for facilitating monetary donations to user preferred charitable entities.

### SUMMARY OF THE INVENTION

Without limitation, the present method and system for facilitating donations to user preferred causes may be implemented as a web browser extension, as a mobile application, or as an application run locally on a user's machine. Herein, the terms “cause”, “cause(s)”, and “causes” include, but are not limited to, private independent foundations, publicly supported entities, charities supported by gifts, dues and fees, privately operating foundations, non-profit organizations, social advocacy groups, and the like.

Prior to a user practicing the systems and methods disclosed herein, a plurality of data values corresponding to the user's preferred method(s) of payment and preferred cause(s) to donate to are collected and stored in a memory. The disclosed systems comprise one or more devices configured to collect and/or determine, and store the plurality of data.

Herein, the collected plurality of data values corresponding to the user's preferred method(s) of payment are referred to as “payment method information”. The payment method information may include, but is not limited to, data values required to electronically transfer monetary donations using credit cards, mobile payments, bank transfers, e-wallets, prepaid cards, direct deposits, PayPal, Stripe, Amazon Pay, X-Payments, Braintree, Due, GoCardless, SecurePay, Adyen, CyberSource, or other payment methods known in the field of commerce. In the preferred embodiment, the payment method information is verified to correspond to a valid method of payment using a payment processor or the like. In the preferred embodiment, once the payment method information is verified as corresponding to a valid payment method, the valid payment method is then confirmed by the user as their chosen method of payment for donations when using the disclosed systems and performing the disclosed methods. Once the user confirms their payment method of choice, the payment method information corresponding to their payment method of choice is stored in a memory of a device configured to be used by the systems disclosed herein.

In some embodiments, the payment method information is stored locally on a user device and retrieved using browser APIs. Other embodiments utilize a plurality of other information storage and retrieval methods readily known and apparent to those skilled in the art to store and retrieve a user's payment method information.

Herein, the plurality of data values corresponding to the user's preferred donation causes is referred to as “preferred causes information”. Preferred causes information can be collected and/or determined by a plurality of methods including, but not limited to, prompting the user to select one or more causes from a predefined set of a plurality of causes or by prompting the user to manually enter payment receival information associated with their preferred causes. In some embodiments, the predefined set of a plurality of causes is personalized as it is generated by the system based on the user's preferences, browsing history, previous donation trends, and the like. In the preferred embodiment, once the user selects their preferred causes, the user then confirms the selected preferred causes as acceptable causes for future donations when using the disclosed systems and performing the disclosed methods. Once the user confirms their causes of choice to donate too, the preferred causes information corresponding to their selected causes is stored in a memory of a device configured to be used by the systems disclosed herein.

In some embodiments, the preferred causes information is configured to be stored locally and retrieved using browser APIs. Other embodiments may utilize any of a plurality of other information storage and retrieval methods readily known and apparent to those skilled in the art.

The above steps of collecting, verifying, confirming, and storing user preferred payment information and user preferred causes information are not necessarily performed in the aforementioned order.

After the user payment method information and user preferred causes information is stored, the systems and methods disclosed herein may be practiced by the user. Herein, “commerce” refers to the buying of products or services. Herein, “shopping cart area” will refer to a webpage or web storefront containing information about payment methods and merchandise/service costs when shopping online.

The methods disclosed herein begin by the system detecting the user engaging in electronic commerce. Once user engagement is detected, a donation amount is determined and displayed to the user for confirmation. If the user does not confirm the displayed dotation amount, the user is prompted to manually input a custom donation amount of their choice. The custom donation amount may be greater than, equal too, or less than the originally displayed donation amount. A custom donation amount of $0.00 will result in the donation transaction not being executed. If the user confirms the displayed donation amount, the displayed donation amount is transferred from the stored user preferred methods of payment to the user preferred causes.

In some embodiments, not manually inputting a custom donation will redirect the user to their account settings where the user may then configure their account settings so that not confirming the displayed donation amount will end the process and the user will not be prompted to manually input a donation amount of their choice.

Many charitable organizations have donation systems in place that encourage a minimum donation of a certain value for a desired effect. For example, a user preferred cause may plant one tree if $5.00 is donated or it may plant five trees if $15.00 is donated. In such cases, one donation option results in a greater positive impact per dollar donated.

To take advantage of such donation systems, some embodiments of the present invention utilize donation batching. In the preferred embodiment, the user will have the option to enable or disable donation batching.

If donation batching is disabled, the aforementioned method is used. If donation batching is enabled, once the user confirms the displayed donation amount or inputs a custom donation amount, the displayed donation amount or the custom donation amount, respectively, will be deducted from the user confirmed payment method and cumulatively added to any previously stored donations stored in a system wallet. If the addition of the most recent donation amount reaches the batching threshold associated with the user preferred causes, the total donation amount stored in the system wallet will be transferred from the system wallet to the user preferred causes.

In some embodiments, once the hatching threshold is reached, the transfer of funds from the system wallet to the user preferred causes is automatic. In other embodiments, the user is prompted to confirm or deny the sending of the donation.

In some embodiments, the entirety of the aforementioned methods are configured to be automatic, wherein a user's shopping cart area is modified simply by engaging in commerce and wherein a user is not required to confirm donation amounts for the donation transaction to be executed.

In some embodiments, after the transfer of the donation amount to user preferred causes is executed, an impact score is calculated and displayed to the user. An impact score is a quantitative or qualitative representation of the tangible effect of a donation based on the donation amount and the cause to which the donation amount was sent. Impact scores are used to provide users a perspective on the impact which their donations have as a means of encouragement for users to regularly donate.

### BRIEF DESCRIPTION OF THE DRAWINGS

This invention will be better understood with reference to the following drawings, flowcharts, and figures, which are intended to illustrate specific embodiments within the overall scope of the invention as claimed:

FIG. 1 is a diagram of an example computer system environment in which systems and/or methods, described herein, may be implemented;

FIG. 2 shows a block diagram with components of a computing device that may be used with one or more embodiments of the invention;

FIG. 3 is a flowchart illustrating the steps of the method for setting up the system prior to implementing methods described herein;

FIG. 4 is a flowchart illustrating the steps of the method for facilitating donations to user preferred causes according to a first embodiment of the invention that not use donation batching;

FIG. 5 is a flowchart illustrating the steps of the method for facilitating donations to user preferred causes according to a second embodiment of the invention that uses donation batching and wherein donation batching is enabled; and,

FIG. 6 is a flowchart illustrating the steps of calculating and displaying an impact score to a user.

### DETAILED DESCRIPTION

In the following description, to better understand the aforementioned purposes, features, and advantages of the present invention, numerous specific details are set forth in order to provide a thorough understanding of the subject matter. It should be noted that these details and examples are provided to merely aid in understanding the descriptions, and they do not, in any way, limit the scope of the present invention. The present invention can also be implemented in other modes different from those described herein and the present invention is not limited to the specific embodiments disclosed below.

The present invention may be a system, a method, and/or a computer program product at any possible technical detail level of integration. The computer program product may include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including, but not limited to, an object-oriented programming language such as Python, Java, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While particular embodiments have been shown and described throughout this application, it will be obvious to those skilled in the art that, based upon the teachings herein, that changes and modifications may be made without departing from the scope of the present invention.

As used herein, the term “user” may refer to any entity or individual associated with the method and system for facilitating donations to user preferred causes. In some embodiments, a user may be a computing device user, a phone user, and/or a mobile device application user. Furthermore, the terms “user” and “individual” may be used interchangeably throughout this specification.

As used herein the term “user device” may refer to any device that employs a processor and memory and can perform computing functions and collect a plurality of data values from a user, such as a personal computer or a mobile device, wherein a mobile device is any mobile communication device, such as a cellular telecommunications device (i.e., a cell phone or mobile phone), a mobile Internet accessing device, or other mobile device. Other types of mobile devices may include laptop computers, tablet computers, wearable devices, cameras, video recorders, audio/video players, radio, global positioning system (GPS) devices, portable digital assistants (PDAs), automated teller machines (ATMs), or any combination of the aforementioned. The device may be used by the user to access the system directly or through an application, online portal, internet browser, virtual private network, cloud server, or other connection channel.

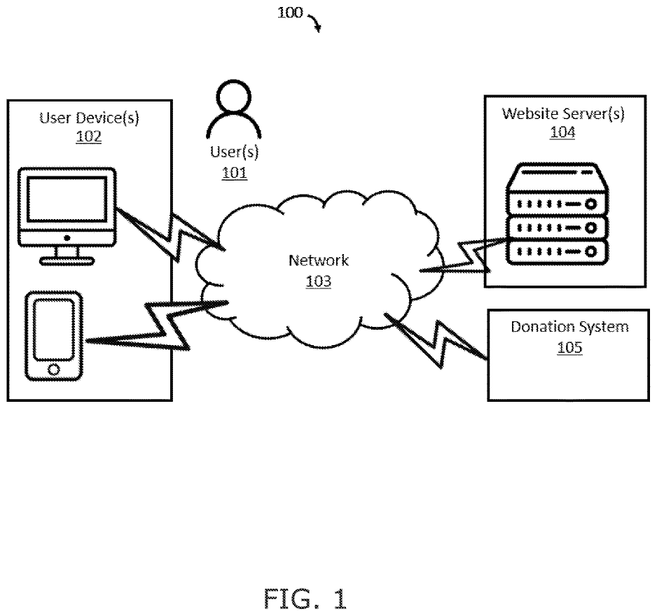

FIG. 1 is a diagram of an example computer system environment in which systems and/or methods, described herein, may be implemented. As illustrated in FIG. 1, various user devices 102 can be used to access a donation system 105. A user device 102 is in communication with the donation system 105 to donation system using a network 103 to transmit and/or retrieve information to/from the donation system 105. The user device 102 can be any computing devices capable of receiving user input as well as transmitting and/or receiving data via the network 103. In some embodiments, the user device 102 is a mobile device having computing and commerce functionality, such as a personal digital assistant, mobile telephone, smartphone, or similar device. In some embodiments, the user device 102 executes an application allowing the device's user 101 to communicatively interact with the donation system 105 and a commerce web storefront or application hosted on one or more website servers 104. For example, and without limitation, the user device 102 is configured to execute a browser application to enable interaction between the user device 102, a commerce web storefront or application hosted on the one or more website servers 104, and the donation system 105 using the network 103. In other embodiments, the user device 102 is communicatively coupled with the donation system 105 through an application program interface (API) that runs on the native operating system of the user device 102, such as IOS or ANDROID.

In some embodiments, the donation system 105 is stored, accessed, and used locally on user device 102.

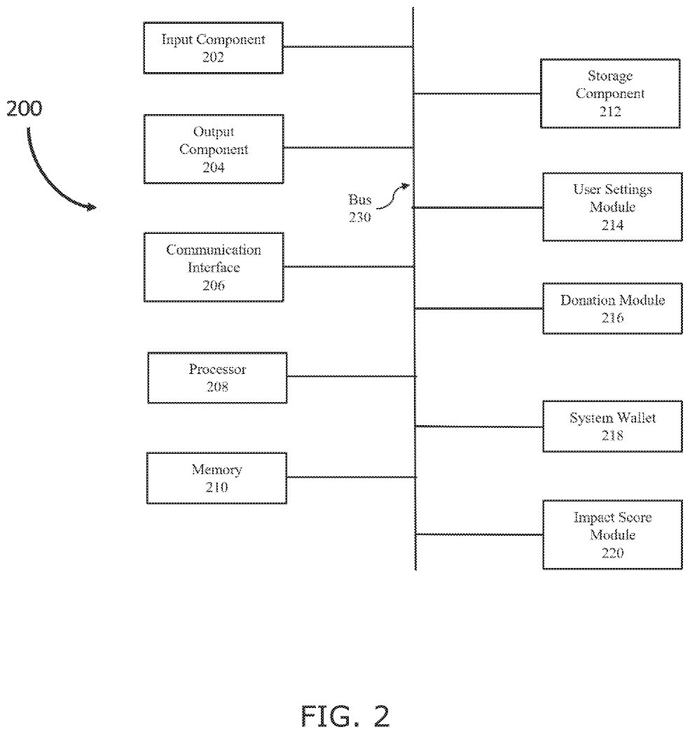

FIG. 2 shows a block diagram with components of a computing device 200 that may be used with one or more embodiments of the invention. The device 200 may include an input component 202, an output component 204, a communication interface 206, a processor 208, a memory 210, a storage component 212, a user settings module 214, a donation module 216, a system wallet 218, an impact score module 220, and a bus 230. Other embodiments of the present invention may include some, all, or none of these modules and components along with other modules, applications, and/or components. Still yet, some embodiments may incorporate two or more of these modules into a single module and/or associate a portion of the functionality of one or more of these modules with a different module.

The input component 202 includes a component that permits the device 200 to receive information, such as via user input (e.g., a touch screen display, a keyboard, a keypad, a mouse, a button, a switch, and/or a microphone). Additionally, or alternatively, the input component 202 may include a sensor for sensing information (e.g., a global positioning system (GPS) component, an accelerometer, a gyroscope, and/or an actuator).

The output component 204 includes a component that provides output information from the device 200 (e.g., a display, a speaker, and/or one or more light-emitting diodes (LEDs)). Furthermore, in some embodiments, the output component 204 can generate one or more graphical user interface screens. These screens can be used to display information (e.g., information concerning a user's payment methods, donation amounts, preferred causes, etc.). In some embodiments, the graphical user interface screens are configured to facilitate a user setting up user payment methods and/or user preferred causes, to display donation amounts, and/or display donation impacts.

The communication interface 206 includes a transceiver-like component (e.g., a transceiver and/or a separate receiver and transmitter) that enables the device 200 to communicate with other devices, such as via a wired connection, a wireless connection, or a combination of wired and wireless connections. The communication interface 206 may permit the device 200 to receive information from another device and/or provide information to another device. For example, the communication interface 206 may include an Ethernet interface, an optical interface, a coaxial interface, an infrared interface, a radio frequency (RF) interface, a universal serial bus (USB) interface, a wireless local area network interface, a cellular network interface, and/or the like.

The device 200 may perform one or more processes described herein. The device 200 may perform these processes based on the processor 208 executing software instructions stored by a non-transitory computer-readable medium, such as the memory 210 and/or storage component 212. A computer-readable medium is defined herein as a non-transitory memory device. A memory device includes memory space within a single physical storage device or memory space spread across multiple physical storage devices.

The processor 208 is implemented in hardware, firmware, or a combination of hardware and software. The processor 208 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, the processor 208 includes one or more processors capable of being programmed to perform a function. The memory 210 includes a random access memory (RAM), a read only memory (ROM), and/or another type of dynamic or static storage device (e.g., a flash memory, a magnetic memory, and/or an optical memory) that stores information and/or instructions for use by the processor 208.

Software instructions may be read into the memory 210 and/or storage component 212 from another computer-readable medium or from another device via the communication interface 206. When executed, software instructions stored in the memory 210 and/or the storage component 212 may cause the processor 208 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The user settings module 214 is communicably coupled to the memory 210, the storage component 212, and the output component 204 and configured to facilitate a user's setting of preferred payment methods and preferred causes. The user settings module 214 is further configured to provide users access to a donation history and an impact score history.

The memory 210 can be any device, mechanism, or populated data structure used for storing information. In accordance with some embodiments of the present invention, the memory 210 can encompass any type of, but is not limited to, volatile memory, nonvolatile memory, and dynamic memory. For example, the memory 210 can be random access memory, memory storage devices, optical memory devices, magnetic media, floppy disks, magnetic tapes, hard drives, SIMMs, SDRAM, DIMMs, RDRAM, DDR RAM, SODIMMS, erasable programmable read-only memories (EPROMs), electrically erasable programmable read-only memories (EEPROMs), compact disks, DVDs, and/or the like. In accordance with some embodiments, the memory 210 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information which can be used as the memory 210.

The memory 210 may further be used to store instructions for running one or more applications or modules on processor(s) 208. For example, the memory 210 could be used in one or more embodiments to house all or some of the instructions needed to execute the functionality of the input component 202, the output component 204, the communication interface 206, the user settings module 214, the donation module 216, the system wallet 218, and the impact score module 220.

The donation module 216 is communicably coupled to the memory 210, the storage component 212, the user settings module 214, the output component 204, and the system wallet 218, and configured to detect when the user is engaging in commerce, to calculate a donation amount, to display the calculated donation amount to the user, to prompt the user to confirm or deny the calculated donation amount, to allow the user to manually input a custom donation amount, to deduct the donation amount from a user payment method, to deduct the donation amount from the from the system wallet 218, and to initiate/facilitate/complete a donation amount transfer from the user's preferred payment method or from the user's system wallet 218 to the user's preferred causes.

The system wallet 218 is communicably coupled to the memory 210, the user settings module 214, the donation module 216, and the output component 204, and configured to store user donations for batching/aggregation.

An impact score module 220 is communicably coupled to the memory 210, the user settings module 214, and donation module 216, and the output component 204, and configured to calculate a plurality of data values associated with one or more impact scores, to store the plurality of data values in the memory 210 or the storage component 212, and to display the one or more impact scores to the user using the output component 204.

The bus 230 includes a component that permits communication among the components of the device 200.

The number and arrangement of components shown in FIG. 2 are provided as an example. In practice, the device 200 may include additional components, fewer components, different components, or differently arranged components than those shown in FIG. 2. Additionally, or alternatively, a set of components (e.g., one or more components) of the device 200 may perform one or more functions described as being performed by another set of components of device 200.

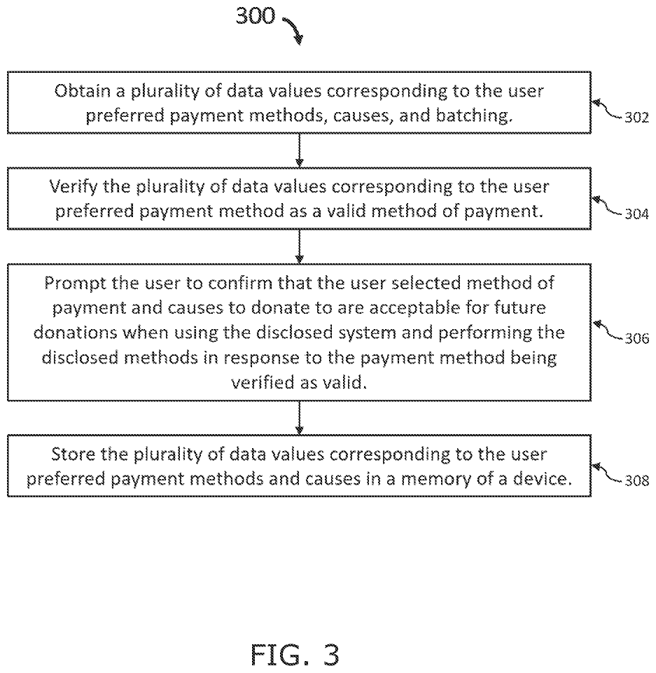

FIG. 3 is a flowchart illustrating the steps of the method 300 for setting up the system prior to implementing methods described herein.

At step 320, a plurality of data corresponding to the user preferred payment methods (payment method information) and causes to donate to (preferred causes information) is obtained from the user via the input component of the user device. In some embodiments, the user settings module is configured to facilitate the entirety of this step.

The payment method information may include, but is not limited to, data values required to electronically transfer monetary donations using credit cards, mobile payments, bank transfers, e-wallets, prepaid cards, direct deposits, PayPal, Stripe, Amazon Pay, X-Payments, Braintree, Due, GoCardless, SecurePay, Adyen, CyberSource, or other payment methods known in the field of commerce.

The preferred causes information can be collected and/or determined by a plurality of methods including, but not limited to, prompting the user to select one or more causes from a predefined set of a plurality of causes or by prompting the user to manually enter payment receival information associated with their preferred causes via the input component of the user device. In some embodiments, the predefined set of a plurality of causes is personalized as it is generated by the system based on the user's preferences, browsing history, previous donation trends, and the like.

At step 304, the payment method information is verified to correspond to a valid method of payment. In some embodiments, payment verification depends on the payment method information. For example, for credit or debit cards, the system may request payment method verification from the payment providers. In some embodiments, the donation system 105 is configured to verify payment methods by communicating with payment providers directly or using third party systems such as money transmitters or payment processors. Other methods and systems of payment method verification known in the art can be utilized without departing from the scope of the present invention.

At step 306, once the payment method information is verified as corresponding to a valid payment method, the user is prompted to confirm that the user input payment method information and preferred causes information is acceptable for use for future donations when using the disclosed systems and performing the disclosed methods.

At step 308, once the user confirms their payment method information and their preferred causes information, the plurality of data values associated with the payment method information and the preferred causes information is stored in the memory of a device utilized by a system disclosed herein. In some embodiments, the payment method information and preferred causes information is stored locally on a user device and retrieved using browser APIs. Other embodiments utilize a plurality of other information storage and retrieval methods readily known and apparent to those skilled in the art to store and retrieve the user payment method information and preferred causes information.

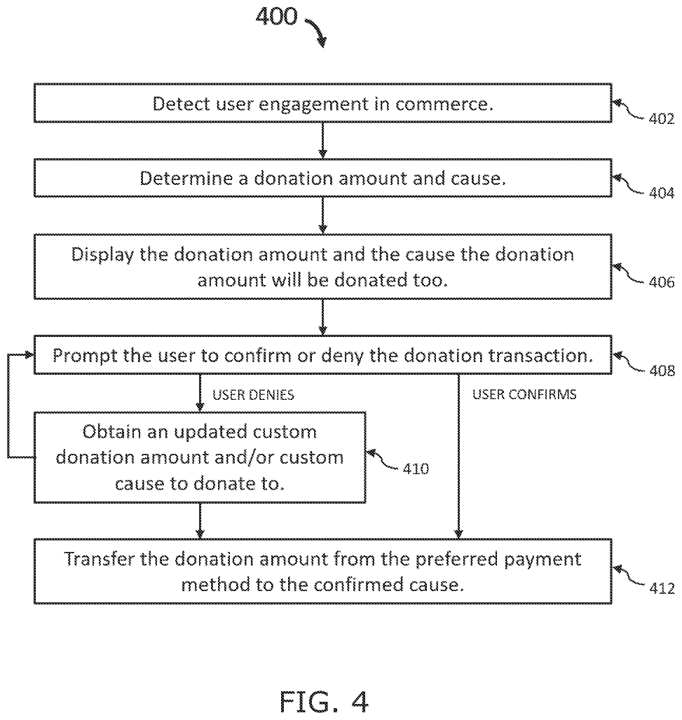

FIG. 4 is a flowchart illustrating the steps of the method 400 for facilitating donations to user preferred causes according to a first embodiment of the invention that not use donation hatching. Preferably, this method is performed by the user after payment method information and preferred causes information are established.

At step 402, if the donation system 105 is actively utilized by the user, the user's engagement in commerce is actively tracked while the user navigates the network/web. Herein, the terms “commerce”, “ecommerce”, “electronic commerce” and the like are not strictly limited as referring to electronically buying or selling of products on online services or over the Internet and can refer to electronically buying or selling non-tangible goods or services as well. User engagement in commerce is detected by the presence of a shopping cart area on the output component of the user device. The donation module 216 is configured to detect the presence of the shopping cart area. In some embodiments, this is done by detecting specific HTML tags commonly associated with shopping cart areas. For example, and without limitation, the HTML tags can include user information associated with an online shopping account, a total checkout cost, and/or a button element to confirm an online purchase. In some embodiments, the donation module 216 is configured to detect JavaScript code used to display elements of a shopping cart area. In such embodiments, the presence of a shopping cart area may be determined if components that are commonly used in shopping cart areas have been dynamically generated using JavaScript. In some embodiments, commerce may be detected by monetary changes in a user payment method transaction history wherein the monetary changes can be used to calculate a donation amount. Furthermore, other embodiments can utilize any of a plurality of other shopping cart area detection methods readily known and apartment to those skilled in the art.

At step 404, the donation module 216 determines the donation amount. In some embodiments, the donation amount is a predetermined amount set by a user through the user settings module 214. In some embodiments, the donation total is calculated as the difference between the total checkout cost of the ecommerce transaction and the rounded-up dollar amount thereof. In some embodiments, the donation amount is calculated as a percentage of the total checkout cost. Other embodiments can utilize any of a plurality of donation calculation methods known to the art without departing from the scope of the present invention.

At step 406, once the donation amount is determined, the donation amount is displayed to the user via the output component 204 of the user device 102 working in conjunction with the donation module 216. In some embodiments, webpage HTML code is modified to display the donation amount on the webpage. In such embodiments, HTML tags corresponding to an area of the shopping cart area that displays the total checkout cost are identified and the shopping cart area's HTML code is modified such that the donation total is embedded onto the page for user viewing. In some embodiments, a pop-up of the donation total is generated and displayed to the user. Other embodiments can utilize any of a plurality of methods to display donation amount information to the user without departing from the scope of the present invention.

In some embodiments, the cause or causes are displayed in close proximity to the donation amount using any of the aforementioned methods to display donation amount information. The cause or causes are based on the user preferred causes selected by the user prior to the using the system.

At step 408, the donation module in conjunction with the output component visually prompts the to confirm or deny the determined and displayed donation amount and/or cause. In some embodiments, the user is given a direct option to cancel the donation associated with their current commerce transaction. In some embodiments, not manually inputting a custom donation total will take the user to their user settings.

If the user denies the displayed donation amount and/or cause, the user is prompted to input a custom donation amount and/or to select a custom cause the donation is for 410. Once the updated custom donation amount and/org the custom cause is input by a user, the user is once again prompted to confirm or deny the donation amount and/or cause 408.

At step 412, which occurs after the user confirms the donation amount and/or cause, the donation module 216 transfers the donation amount from the user preferred payment method to the selected cause.

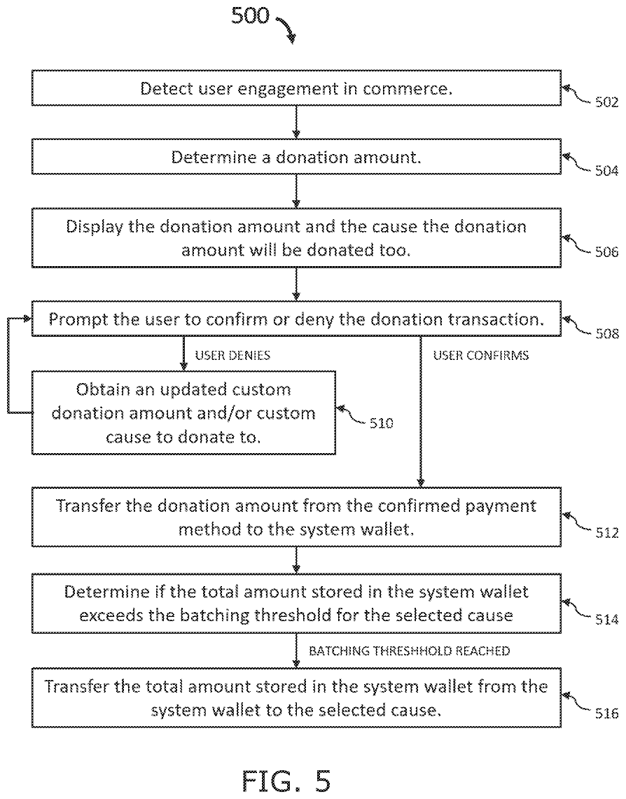

FIG. 5 is a flowchart illustrating the steps of the method 500 for facilitating donations to user preferred causes according to a second embodiment of the invention that uses donation batching and wherein donation batching is enabled. Steps 502, 504, 506, 508, and 510 are analogous to steps 402, 404, 406, 408, and 410 discussed earlier. In this embodiment, a plurality of batching information may be associated with the user selected causes, the plurality of batching information corresponding to various minimum donation amounts or donation tiers recommended/set by an administrator of the donation system 105 or by the causes themselves.

At step 512, the donation module 216 transfers the donation amount from the confirmed payment method to the system wallet.

At step 514, the donation module 216 determines whether the total amount stored in the system wallet 218 exceeds the batching threshold for the selected cause. If the donation module 216 determines that the batching threshold has not been reached, no further steps occur.

At step 516, in response to the donation module 216 determining that the batching threshold has been reached, the donation module 216 transfers the total amount stored in the system wallet from the system wallet to the selected cause.

In some embodiments, at step 506 to encourage greater donations, the donation module 216 may further display information pertaining to the system wallet's stored cumulative monetary amount and the additional amount necessary to reach the one or more greater minimum donation amounts or donation tiers recommended/set by a by the administrator of the donation system 105 or by the causes themselves.

some embodiments of methods 400 and 500, prior to the sending of the donation amount to the user selected cause, the donation module 216 causes the output component 204 to display a plurality of donation options to user wherein the plurality of donation options allows a user to further customization for their donations. In some embodiments, the plurality of donation options, if selected, are configured to facilitates the user adding or removing specific causes that they wish the donation amount to reach. In other embodiments, the plurality of donation options, if selected, are configured to facilitate the user assigning the selected causes a specific percentage of the donation total. Other embodiments may utilize any of a plurality of donation customization methods known in the art without departing from the scope of the present invention.

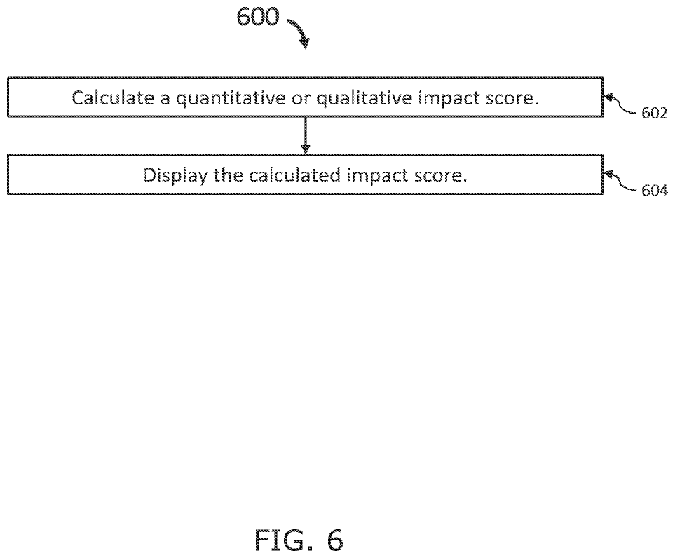

FIG. 6 is a flowchart illustrating the steps of calculating and displaying an impact score to a user. An impact score is a quantitative or qualitative representation of the tangible effect of a donation based on the donation amount and the cause that received the donation amount. Impact scores are used to provide users a perspective on the impact that their donations have as a means of encouragement for users to regularly donate.

At step 602, the impact score module 220 calculates a quantitative or qualitative impact score. In some embodiments, the impact score calculation and display method may be performed in response to a donation being sent to a cause (e.g., following the competition of methods 400 and 500). In other embodiments, the impact score calculation and display method may be manually initiated by a user when the user indicates a request for the impact score to be displayed by selecting this option using the user settings module 214. In some embodiments, the data values corresponding to the impact values of the user's executed donations are stored in memory 201 for later retrieval. In some embodiments, the impact score module 220 causes the output component 204 to display a list of the impact values of the user's previous donations.

In some embodiments, impact scores are quantitative. For example, and without limitation, a quantitative impact score regarding a donation sent to a cause that supports affordable health care may be calculated by the impact score module 220 as follows: The donation amount is divided by the average cost of a medical bill which the cause helps pay off. This results in an impact score that allows the user to determine how many medical bills the user has helped pay off by donating.

In some embodiments, impact scores are qualitative. For example, and without limitation, a qualitative score relating to a user's impact on climate change such as an estimate carbon offset amount accomplished by donating.

At step 604, after an impact score has been calculated, the impact score module 220 causes the output component 204 to display the calculated impact score to the user.

In some embodiments, the donation transactions of methods 400 and 500 occur automatically while the user is engaging in ecommerce without any prompts or donation confirmations being displayed. In such embodiments, the only visual changes a user engaging with the donation system may experience is updated commerce transaction costs that include the donation amount on a webpage or the like.

In some embodiments, the user confirms a donation transaction by completing an ecommerce transaction wherein the only visual difference from the perspective of the viewer is an updated total checkout cost for the underlying ecommerce transaction that includes the donation amount.

In some embodiments, if the user does not select their preferred causes prior to using the systems or performing the methods disclosed herein, the causes that donation amounts will be sent to are predetermined by a donation system administrator or the like.

In the drawings and the description of the drawings herein, certain terminology is used for convenience only, and is not to be taken as limiting the embodiments of the present invention. References to “one embodiment,” “an embodiment,” etc., may indicate that the embodiment(s) of the invention so described may include a particular feature, structure, or characteristic, but not every embodiment necessarily includes the particular feature, structure, or characteristic.

The terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. Also, in the following claims, the terms “including” and “comprising” are open-ended, that is, a system, device, article, or process that includes elements in addition to those listed after such a term in a claim are still deemed to fall within the scope of that claim.

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing implementation of the various embodiments described herein.

It should also be appreciated that various modifications, adaptations, and alternative embodiments thereof may be made within the scope and spirit of the present invention.

What is claimed is:

1. A method of facilitating donations to user preferred causes, the method performed by a processor of a computer, the method comprising:
detecting user engagement in electronic commerce;
determining a donation amount and/or a cause corresponding to an unexecuted donation transaction;
displaying the donation amount and/or the cause to the user; and,
prompting the user to confirm or deny the donation transaction.

2. The method of claim 1, further comprising the steps of:
in response to the user denying the donation transaction:
obtaining an updated donation amount and/or an updated cause from the user, resulting in an updated donation transaction; and,
prompting the user to confirm or deny the updated donation transaction;
in response to the user confirming the donation transaction:
transferring the donation amount from a user preferred payment method to the cause, resulting in an executed donation transaction.

3. The method of claim 2, further comprising the steps of:
calculating an impact score associated with the executed donation transaction; and,
displaying the impact score to the user.

4. The method of claim 3, wherein if the user inputs an updated donation amount of 0, no donation transaction will be executed.

5. The method of claim 3, wherein user engagement in electronic commerce is detected by:
detecting the input of promotion codes or specific Urchin Tracking Module parameters;
detecting HTML tags associated with a shopping cart area or an ecommerce checkout area of a webpage; and/or,
detecting JavaScript code used to display elements of a shopping cart area or an ecommerce checkout area of a webpage.

6. The method of claim 3, wherein the transferring of the donation amount occurs in response to the user completing the commercial transaction associated with the detected user engagement in electronic commerce.

7. The method of claim 3, wherein user confirmation is not required for the execution of the donation transaction such that the donation transaction is automatically executed in response to the user completing the commercial transaction associated with the detected user engagement in electronic commerce.

8. The method of claim 3, wherein displaying the donation amount and/or the cause to the user is accomplished by modifying webpage HTML code to display the donation amount on the webpage associated with the detected user engagement in electronic commerce.

9. The method of claim 3, further comprising, prior to detecting user engagement in electronic commerce, the steps of:
obtaining a plurality of data values corresponding to the user preferred payment methods and causes to donate to;
verifying the plurality of data values corresponding to the user preferred payment method as a valid method of payment;
prompting the user to confirm that the user preferred method of payment and causes to donate to are acceptable for future donations in response to the verification of the user preferred payment method; and,
storing the plurality of data values corresponding to the user preferred payment methods.

10. The method of claim 3, further comprising the steps of:
storing the impact score; and,
displaying a one or more stored impact scored associated with one or more donations to the user.

11. The method of claim 1, further comprising the steps of:
in response to the user denying the donation transaction:
obtaining an updated donation amount and/or an updated cause from the user, resulting in an updated donation transaction;
prompting the user to confirm or deny the updated donation transaction;
in response to the user confirming the donation transaction:
transferring the donation amount from a user preferred payment method to a system wallet;
determining if a total amount stored in the system wallet exceeds a batching threshold of the cause;
transferring the total amount stored in the system wallet from the system wallet to the cause in response to determining that the total amount stored in the system wallet exceeds the hatching threshold of the cause, resulting in an executed donation transaction.

12. The method of claim 10, further comprising the steps of:
calculating an impact score associated with the executed donation transaction; and,
displaying the impact score to the user.

13. The method of claim 11, wherein if the user inputs an updated donation amount of 0, no donation transaction will be executed.

14. The method of claim 11, wherein user engagement in electronic commerce is detected by:
detecting the input of promotion codes or specific Urchin Tracking Module parameters;
detecting HTML tags associated with a shopping cart area or an ecommerce checkout area of a webpage; and/or,
detecting JavaScript code used to display elements of a shopping cart area or an ecommerce checkout area of a webpage.

15. The method of claim 11, wherein the transferring of the donation amount occurs in response to the user completing the commercial transaction associated with the detected user engagement in electronic commerce.

16. The method of claim 11, wherein user confirmation is not required for the execution of the donation transaction such that the donation transaction is automatically executed in response to the user completing the commercial transaction associated with the detected user engagement in electronic commerce.

17. The method of claim 11, further comprising, prior to detecting user engagement in electronic commerce, the steps of:
obtaining a plurality of data values corresponding to the user preferred payment methods and causes to donate to;
verifying the plurality of data values corresponding to the user preferred payment method as a valid method of payment;
prompting the user to confirm that the user preferred method of payment and causes to donate to are acceptable for future donations in response to the verification of the user preferred payment method; and,
storing the plurality of data values corresponding to the user preferred payment methods.

18. The method of claim 11, further comprising the steps of:
storing the impact score; and,
displaying a one or more stored impact scored associated with one or more donations to the user.

19. A non-transitory computer-readable medium, which stores at least the instructions that are executed by a processor to induce a system to:
detect user engagement in electronic commerce;
determine a donation amount and/or a cause corresponding to an unexecuted donation transaction;
display the donation amount and/or the cause to the user;
prompt the user to confirm or deny the donation transaction;
in response to determining that batching is not enabled:
in response to the user denying the donation transaction:
obtaining an updated donation amount and/or an updated cause from the user, resulting in an updated donation transaction; and,
prompting the user to confirm or deny the updated donation transaction;
in response to the user confirming the donation transaction:
transferring the donation amount from a user preferred payment method to the cause, resulting in an executed donation transaction;
in response to determining that hatching is enabled:
in response to the user denying the donation transaction:
obtaining an updated donation amount and/or an updated cause from the user, resulting in an updated donation transaction;
prompting the user to confirm or deny the updated donation transaction;
in response to the user confirming the donation transaction:
transferring the donation amount from a user preferred payment method to a system wallet;
determining if a total amount stored in the system wallet exceeds a batching threshold of the cause; and,
transferring the total amount stored in the system wallet from the system wallet to the cause in response to determining that the total amount stored in the system wallet exceeds the batching threshold of the cause, resulting in an executed donation transaction.

20. The non-transitory computer-readable medium of claim 19, which further stores at least the instructions that are executed by a processor to induce a system to:
in response to an executed donation transaction:
calculate an impact score associated with the executed donation transaction; and,
display the impact score to the user.
